(19) United States
(12) Patent Application Publication
(10) Pub. No.: US 2025/0258137 A1
(43) Pub. Date: Aug. 14, 2025

(54) ULTRASONIC CAVITATION SENSOR

(71) Applicant: ZEVEX, INC., Salt Lake City, UT (US)

(72) Inventors: Robert GWYNN, Bountiful, UT (US); John FOLEY, West Valley City, UT (US); Myra FLITCROFT, Salt Lake City, UT (US); Mark STRINGHAM, Kearns, UT (US); Nathan J. PIERCE, Vinton, VA (US)

(21) Appl. No.: 18/856,653

(22) PCT Filed: Jun. 26, 2023
(86) PCT No.: PCT/US2023/069045

§ 371 Date: Oct. 14, 2024

Related U.S. Application Data
(60) Provisional application No. 63/356,201, filed on Jun. 28, 2022.

(51) Int. Cl. G01N 29/032; G01N 29/22; G01N 29/48

(52) U.S. Cl. CPC G01N 29/032; G01N 29/222; G01N 29/48; G01N 2291/02433; G01N 2291/101

(57) ABSTRACT

An apparatus for sensing cavitation in liquid flowing through a conduit in a housing includes an ultrasonic transducer system having one or more ultrasonic transducers attached to the housing and arranged in acoustic communication with the liquid, and control electronics connected to the ultrasonic transducer system. The control electronics is configured to drive the transducer system to send an ultrasonic signal through the flowing liquid, wherein the transducer system receives the ultrasonic signal and generates an electronic cavitation detection signal representing a strength of the received ultrasonic signal. The control electronics is further configured to process the cavitation detection signal to provide a cavitation measurement signal indicative of whether or not the ultrasonic signal interacted with one or more cavitation bubbles, evaluate the cavitation measurement signal to determine if one or more alarm conditions is met, and output an alarm signal when each of the cavitation alarm condition(s) is met.

### CROSS-REFERENCE TO RELATED APPLICATION

The present application claims priority benefit of U.S. Provisional Patent Application No. 63/356,201 filed Jun. 28, 2022, the entire disclosure of which is incorporated herein by reference.

### FIELD OF THE DISCLOSURE

The present disclosure relates to sensors for detecting cavitation and other properties of flow though liquid pumps and liquid piping systems.

### BACKGROUND OF THE DISCLOSURE

Cavitation is a phenomenon that occurs frequently in liquid pumps and piping systems. It can be caused by restrictions of flow in the pump or piping, or by other conditions which produce a low pressure resulting in the formation of cavitation vapor bubbles. A cavitation bubble differs from an air bubble in that the cavitation bubble or void consists of vapor of the surrounding liquid medium. For example, in a pump and piping system for water, the cavitation bubbles consist of water vapor (i.e., cold steam), not air. Cavitation vapor bubbles may collapse upon surfaces of a pump impeller, valve, or piping and cause surface damage due to the extreme localized pressures involved. Detection of cavitation is important in order to control its occurrence and minimize costly component damage.

Currently, cavitation is detected by indirect sensing methods. It is known to detect cavitation by means of acoustic sensors listening for sound produced by collapsing cavitation bubbles as they impinge upon surfaces of a pump, valve, pipe, or other component of a liquid flow system. Another known method for indirectly detecting cavitation is to sense vibrations on the pump housing or piping. Still further methods for indirectly detecting cavitation include sensing a significant change in pump impeller speed or current draw, or measuring a significant pressure drop in the liquid flow system. The known methods mentioned above detect an artifact of cavitation (e.g., noise, vibration, pump behavior) as the cavitation vapor bubbles cause damage to system components, and therefore are of limited value in preventing such damage. The use of acoustic sensors is unsuited for noisy environments.

Cavitation may be directly detected by visual observation, however this requires transparent piping be used in the liquid flow system, and the cavitation vapor bubbles must be large enough to permit visual or optical observation.

An improved solution for detecting cavitation is needed.

### SUMMARY OF THE DISCLOSURE

The present disclosure provides an apparatus and method for directly sensing cavitation bubbles in liquid flowing through a conduit prior to collapse of the cavitation bubbles on a surface.

In one embodiment, a cavitation sensor module may comprise a pipe segment adapted for installation in piping of a liquid flow system, one or more first transducer plugs each having a first ultrasonic transducer for sending ultrasonic signals, one or more second transducer plugs each having a second ultrasonic transducer for receiving the ultrasonic signals from a first ultrasonic transducer paired therewith, and a controller circuit board assembly connected to each first ultrasonic transducer and each second ultrasonic transducer. The cavitation sensor module may further comprise an enclosure for protecting the first and second transducer plugs and controller circuit board assembly, and for securing the transducer plugs and controller circuit board assembly to the pipe segment.

The controller circuit board assembly may include an electronic controller and related circuitry configured to execute stored programming instructions to drive each first ultrasonic transducer and process a cavitation detection signal generated by each second ultrasonic transducer to establish a cavitation measurement signal. The electronic controller may execute stored programming instructions to compare the cavitation measurement signal to a predetermined cavitation threshold value. The controller may be programmed and configured such that when the amplitude of the cavitation measurement signal drops below the cavitation threshold value, an alarm is signaled by the controller. The strength of the ultrasonic signal generated by each first ultrasonic transducer, and a gain applied to the cavitation detection signal generated by each second ultrasonic transducer upon receiving the ultrasonic signal, may be controlled and adjusted by the controller. A count of bubbles and/or an accumulation of cavitation events present in the flowing liquid may be calculated by the controller to provide additional information to a user.

The enclosure may be a multi-piece enclosure having a plurality of pieces which may be disassembled and assembled for installing the cavitation sensor module in a liquid flow system. In one embodiment, the enclosure includes a central piece dimensioned to receive the controller circuit board assembly and a first radial portion of the pipe segment, a cover piece removably attached to the central piece and dimensioned to cover the controller circuit board assembly, and a securement piece removably attached to the central piece and dimensioned to receive a second radial portion of the pipe segment opposite the first radial portion of the pipe segment to secure the enclosure on the pipe segment.

In another embodiment, a cavitation sensor apparatus is similar to the sensor module summarized above, except that the control electronics are housed in an enclosed control unit located remote from a housing (e.g., a pipe segment, pump housing, valve housing, fitting, or other housing) where the liquid flow conduit is located.

In further variants, the cavitation sensor apparatus does not comprise its own housing defining the liquid conduit, and is installed on a housing (e.g., a pipe, a pump housing, a valve housing, a fitting, or another housing) of an existing component in a liquid flow system. The further variants include noninvasive clamp-on and bonded-on variants.

The cavitation sensing apparatus of the present disclosure may include a user interface, for example an external computing device, connected to the control electronics. The user interface may be configured to display the cavitation measurement signal and/or a value representing an instantaneous strength of the cavitation measurement signal. The user interface may be configured to receive a first variable user input for establishing a cavitation alarm set point. The user interface may also be configured to receive a second variable user input for establishing a cavitation error count setting for reducing nuisance alarms.

### BRIEF DESCRIPTION OF THE DRAWING VIEWS

The nature and mode of operation of the present disclosure will now be more fully described in the following detailed description taken with the accompanying drawing figures, in which:

FIG. 1A is a schematic illustration of an ultrasonic cavitation sensor according to an embodiment of the present disclosure, viewed along an axial flow direction of a pipe conduit associated with the cavitation sensor, wherein no cavitation bubble is present in liquid flowing through the pipe;

FIG. 1B is a schematic illustration similar to that of FIG. 1A, wherein a cavitation bubble is present in liquid flowing through the pipe conduit;

FIG. 1C is a schematic illustration of an ultrasonic cavitation sensor according to another embodiment of the present disclosure, viewed along an axial flow direction of a pipe conduit associated with the cavitation sensor, wherein no cavitation bubble is present in liquid flowing through the pump conduit;

FIG. 1D is a schematic illustration similar to that of FIG. 1C, wherein a cavitation bubble is present in liquid flowing through the pipe conduit;

FIG. 2 is a perspective view of an ultrasonic cavitation sensor module according to an embodiment of the present disclosure;

FIG. 3 is a side view of the cavitation sensor module shown in FIG. 2;

FIG. 4 is another perspective view of the cavitation sensor module shown in FIG. 2, wherein a top cover of an enclosure of the cavitation sensor module is removed;

FIG. 5 is a further perspective view of the cavitation sensor module shown in FIG. 2, wherein the entire enclosure of the cavitation sensor module is removed;

FIG. 6 is a view of the cavitation sensor module shown in FIG. 5 with the cover removed, viewed along an axial flow direction of a pipe segment of the cavitation sensor module;

FIG. 7 is an exploded perspective view of a transducer plug of the cavitation sensor module shown in FIG. 2;

FIG. 8 is a cross-sectioned perspective view of the transducer plug shown in FIG. 7;

FIG. 9 is a schematic block diagram of an electronic controller board assembly of the cavitation sensor module shown in FIG. 2;

FIG. 10 is a perspective view of an ultrasonic cavitation sensor apparatus according to another embodiment of the present disclosure;

FIG. 11 is a perspective view of a control unit of the ultrasonic cavitation sensor apparatus shown in FIG. 10, wherein a front panel of the control unit is removed to reveal internal components of the control unit;

FIG. 12 is a cross-sectioned perspective view of a pipe segment and ultrasonic transducer system of the ultrasonic cavitation sensor apparatus shown in FIG. 10;

FIGS. 13A through 13C are perspective views showing various type of pipe segments that may be used in the ultrasonic cavitation sensor apparatus;

FIG. 14 is a perspective view of an ultrasonic transducer plug of the ultrasonic cavitation sensor apparatus;

FIG. 15 is a cross-sectional view of the ultrasonic transducer plug shown in FIG. 14;

FIG. 16 is a perspective view of a pump formed in accordance with a variant of the present disclosure, wherein an ultrasonic cavitation sensor apparatus of the present disclosure is associated with a housing of the pump;

FIG. 17 is a partially sectioned side view of the pump and a transducer portion of the ultrasonic cavitation sensor apparatus shown in FIG. 16;

FIG. 18 is a perspective view of a valve formed in accordance with a variant of the present disclosure, wherein an ultrasonic cavitation sensor apparatus of the present disclosure is associated with a housing of the valve;

FIG. 19 is an axial cross-sectional view of the valve and ultrasonic cavitation sensor apparatus shown in FIG. 18;

FIG. 20 is a perspective view of a clamp-on ultrasonic cavitation sensor module according to a further embodiment of the present disclosure, connected to a pipe segment;

FIG. 21 is a cross-sectional view of the clamp-on module and pipe segment shown in FIG. 20;

FIG. 22 is a cross-sectional view of an ultrasonic transducer plug of the clamp-on module shown in FIG. 20;

FIG. 23 is a perspective view of showing an ultrasonic cavitation sensor arrangement using bonded transducers on a flow reducer fitting according to another embodiment of the present disclosure;

FIG. 24 is an exploded a perspective view of the ultrasonic cavitation sensor arrangement shown in FIG. 23;

FIG. 25 is a cross-sectional view of the ultrasonic cavitation sensor arrangement shown in FIG. 23;

FIG. 26A is view showing a user interface display screen of the ultrasonic cavitation sensor apparatus, wherein no cavitation bubbles are present in liquid monitored by the apparatus; and

FIG. 26B is view similar to that of FIG. 26A, wherein cavitation bubbles are present in liquid monitored by the apparatus.

### DETAILED DESCRIPTION

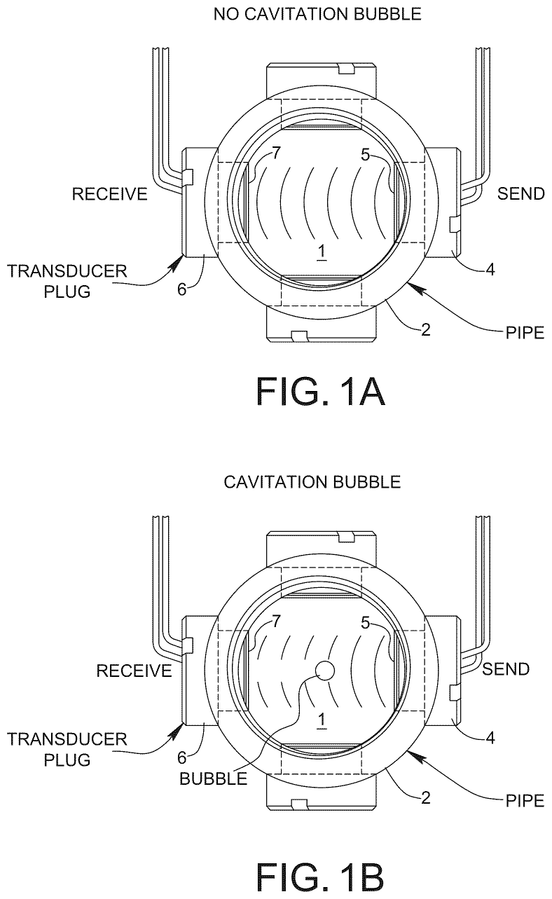

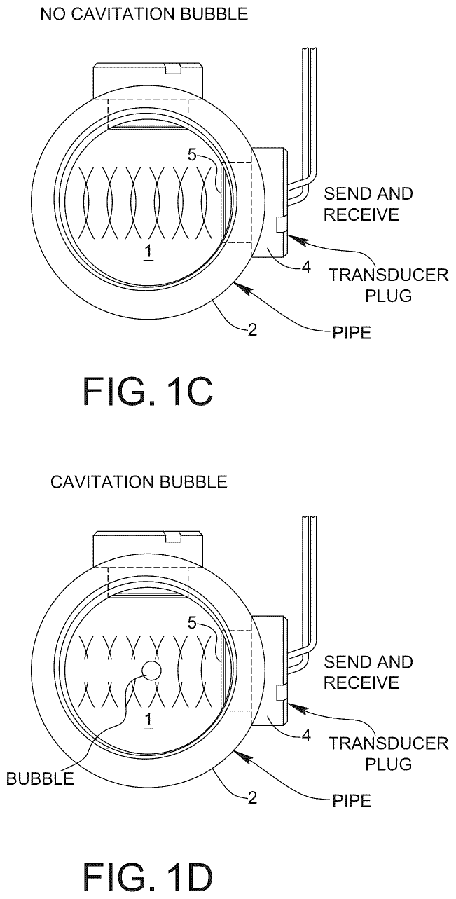

FIGS. 1A and 1B schematically illustrate a configuration for direct ultrasonic detection of cavitation bubbles prior to collapse of the cavitation bubbles on a surface. In both figures, liquid flows through a conduit 1 of a pipe 2 in an axial direction of the pipe conduit, i.e., in a direction normal to the plane of the drawing sheet. Installed on one side of pipe 2 is a first transducer plug 4 extending through a wall of the pipe and having a first ultrasonic transducer 5 in acoustic communication with liquid flowing through the pipe. Installed on an opposite side of pipe 2 is a second transducer plug 6 extending through the pipe wall and having a second ultrasonic transducer 7 in acoustic communication with liquid flowing through the pipe conduit 1. As may be seen, second ultrasonic transducer 7 faces first ultrasonic transducer 5 along a transverse direction perpendicular to the axial direction of pipe conduit 1 across the liquid flowing through the pipe conduit. First ultrasonic transducer 5 may be driven to send an ultrasonic signal in the form of a series of waves propagating through the liquid flowing in pipe conduit 1 toward second ultrasonic transducer 7. Second ultrasonic transducer 7 is arranged to receive the ultrasonic signal transmitted by first ultrasonic transducer 5, and is configured to generate an electronic cavitation detection signal representing a strength of the ultrasonic signal it receives from first ultrasonic transducer 5. For example, paired first and second ultrasonic transducers 5, 7 may be piezoelectric transducers operating in an ultrasonic frequency range.

If the liquid flowing through pipe conduit 1 has no cavitation bubbles to impede the ultrasonic signal as the ultrasonic signal travels across the liquid in the pipe conduit 1, as illustrated in FIG. 1A, then the cavitation detection signal generated by second ultrasonic transducer 7 has a relatively high amplitude. However, if one or more cavitation bubbles are present in the flowing liquid, as illustrated in FIG. 1B, then the ultrasonic signal is attenuated to a greater degree than in FIG. 1A, less energy is received at second ultrasonic transducer 7, and the cavitation detection signal generated by second ultrasonic transducer 7 has a reduced amplitude as compared to the cavitation-free condition of FIG. 1A. The strength of the cavitation detection signal is a relative indicator of the size and/or number of cavitation bubbles present between first ultrasonic transducer 5 and second ultrasonic transducer 7.

As described in detail below, an electronic controller and related circuitry connected to ultrasonic transducers 5, 7 may be configured to execute stored programming instructions to drive first ultrasonic transducer 5 and process the cavitation detection signal generated by second ultrasonic transducer 7 to establish a cavitation measurement signal and compare the cavitation measurement signal to a predetermined cavitation threshold value. The controller may be programmed and configured such that when the amplitude of the cavitation measurement signal drops below the cavitation threshold value, an alarm is signaled by the controller. The strength of the ultrasonic signal generated by first ultrasonic transducer 5, and a gain applied to the cavitation detection signal generated by second ultrasonic transducer 7 upon receiving the ultrasonic signal, may be controlled and adjusted by the controller. A count of bubbles or an accumulation of cavitation present in the flowing liquid may be calculated by the controller to provide additional information to a user.

FIGS. 1C and 1D schematically illustrate a variant configuration for direct ultrasonic detection of cavitation bubbles prior to collapse of the cavitation bubbles on an internal surface of a liquid conduit 1 which operates using retro-reflection of ultrasonic signals, also referred to as a “pulse-echo” mode of operation. In contrast to the configuration illustrated in FIGS. 1A and 1B, the configuration of FIGS. 1C and 1D has a single ultrasonic transducer 5 operating as both a transmitter and receiver. Ultrasonic transducer 5 may be driven to send an ultrasonic signal propagating through the liquid flowing in liquid conduit 1 toward an opposing internal wall surface 3 of conduit 1, and is arranged to receive the ultrasonic signal after it has been retro-reflected by surface 3 back toward ultrasonic transducer 5. Ultrasonic transducer 5 is configured to generate an electronic cavitation detection signal representing a strength of the received ultrasonic signal. In a “pulse-echo” configuration, the electronic controller and related circuitry may be connected to ultrasonic transducer 5 and configured to execute stored programming instructions to drive the ultrasonic transducer 5, and to process the cavitation detection signal generated by the ultrasonic transducer 5 in a manner similar to that described above in relation to FIGS. 1A and 1B and second ultrasonic transducer 7.

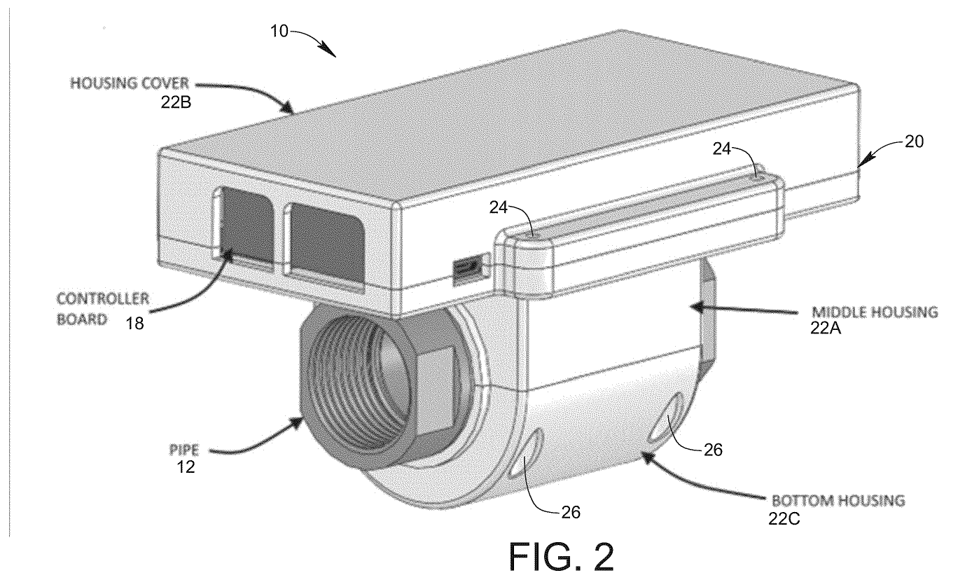

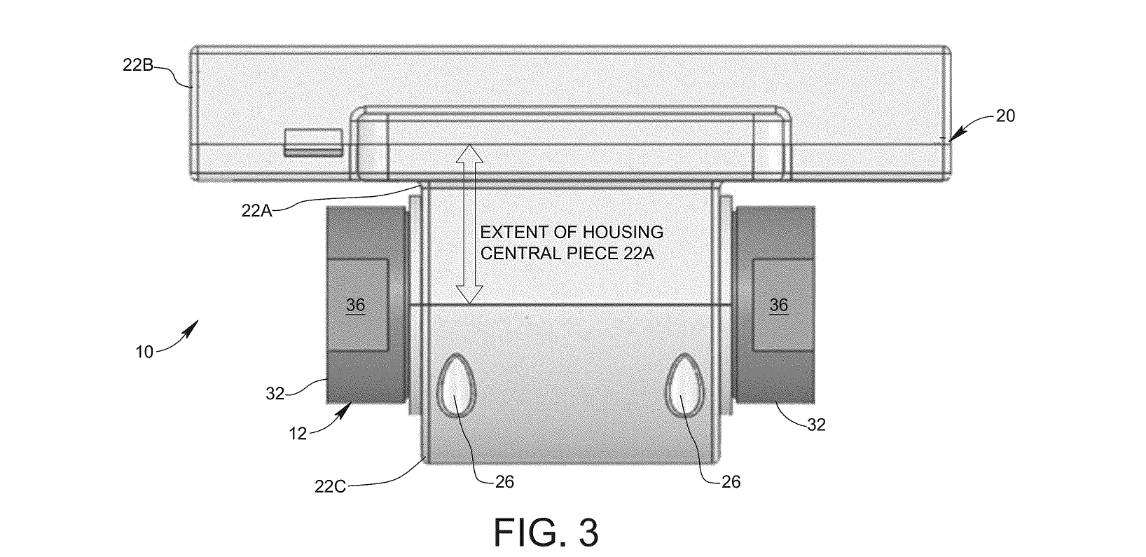

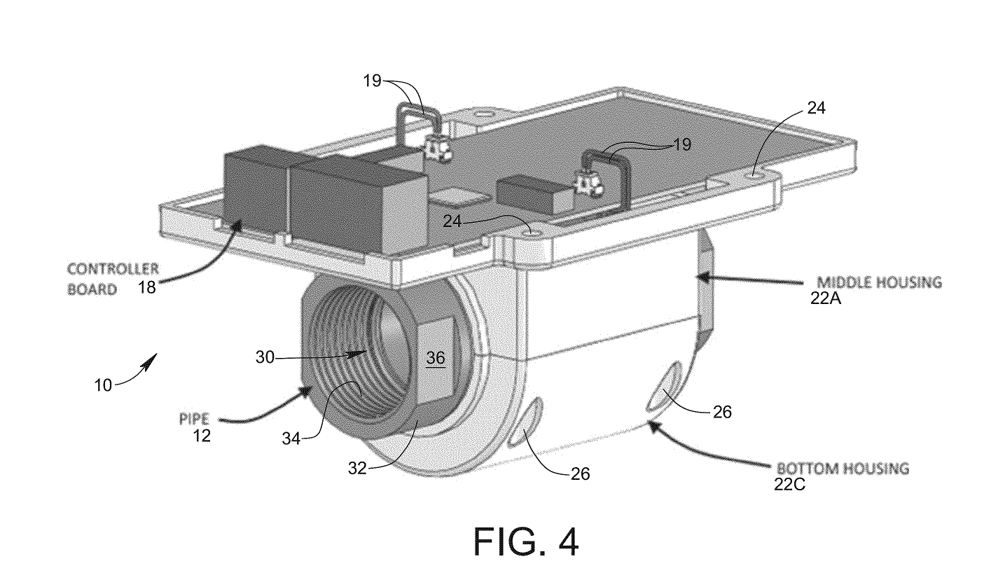

FIGS. 2 through 9 illustrate a cavitation sensor module 10 formed in accordance with an exemplary embodiment of the present disclosure. Cavitation sensor module 10 is intended to be installed in a piping system (not shown) for conveying flow of a liquid. For example, cavitation sensor module 10 may be installed in industrial and structural hydraulic systems, liquid cooling systems such as those used at computer server farms, drinking water and wastewater systems, mining and agricultural liquid flow systems, and any liquid pumping systems where the potential for cavitation damage exists.

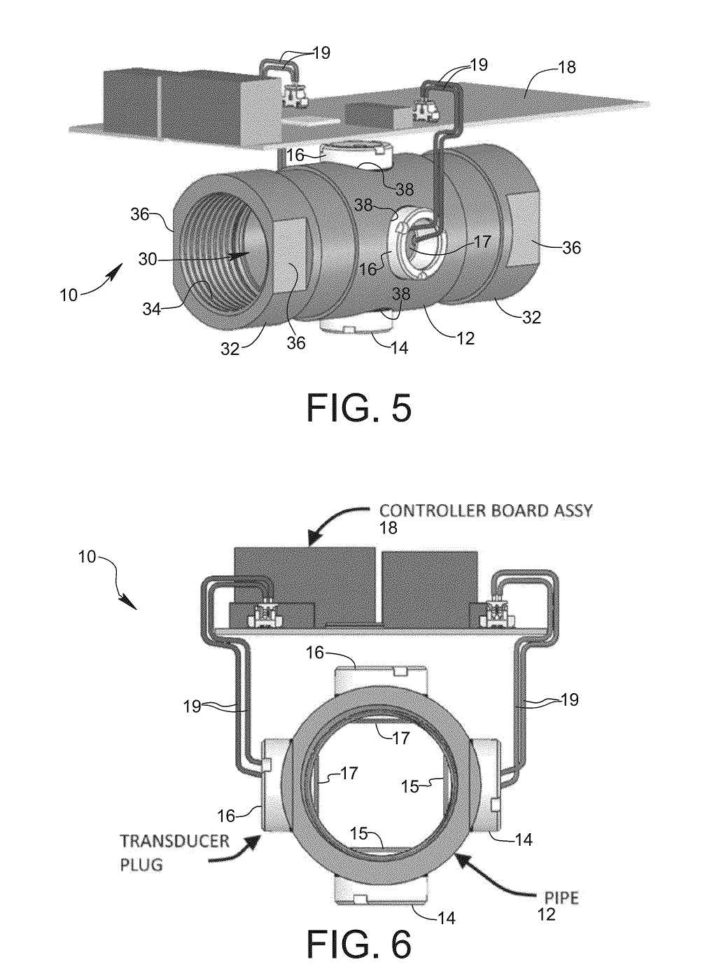

Cavitation sensor module 10 may comprise a pipe segment 12, one or more first transducer plugs 14 each having a first ultrasonic transducer 15, one or more second transducer plugs 16 each having a second ultrasonic transducer 17 to be paired with a corresponding first ultrasonic transducer 15, and a controller circuit board assembly 18 connected to each first ultrasonic transducer 15 and each second ultrasonic transducer 17. In FIGS. 5 and 6, connection wiring 19 is shown for connecting only one pair of ultrasonic transducers 15, 17 to controller circuit board assembly 18, and connection wiring for additional ultrasonic transducers 15, 17 is not shown for sake of clarity. However, if additional ultrasonic transducers are used by sensor module 10, the additional ultrasonic transducers are also connected to controller circuit board assembly 18. Cavitation sensor module 10 may further comprise an enclosure 20 for protecting first and second transducer plugs 14, 16 and controller circuit board assembly 18, and for securing the transducer plugs and controller circuit board assembly to pipe segment 12.

As best seen in FIG. 5, pipe segment 12 may be a straight length of metal or plastic pipe defining a liquid flow conduit 30 through which liquid flows. Pipe segment 12 may include couplings 32 at opposite ends thereof for connecting pipe segment 12 to piping of the liquid flow system in which cavitation sensor module 10 is installed. For example, couplings 32 may be standard pipe couplings each having an internally threaded portion 34 for mating with system piping and external flats 36 for facilitating application of torque to pipe segment 12. The configuration of couplings 32 may be chosen for compatibility with the piping specifications of the liquid flow system in which cavitation sensor module 10 is installed. Pipe segment 12 may further includes a plurality of ports 38 extending through the wall of the pipe segment, for example in a radial direction through the wall of the pipe segment, for receiving and positioning transducer plugs 14 and 16. Of course, pipe segment 12 may be other than a straight segment, i.e., liquid flow conduit 30 may be bent to change flow direction.

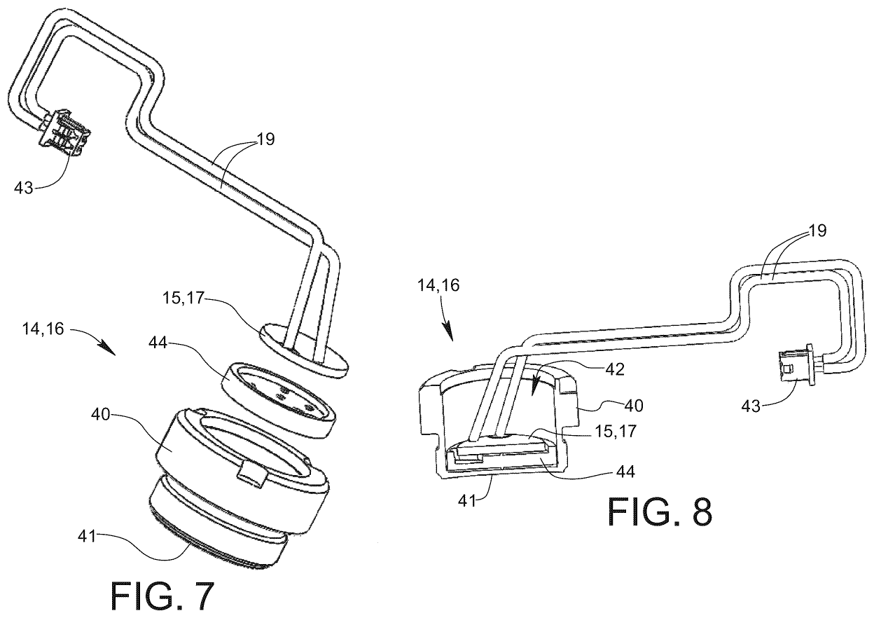

Specific reference is now made to FIGS. 7 and 8 for description of transducer plugs 14, 16 according to an embodiment of the disclosure. Each transducer plug 14, 16 may include a shell 40 dimensioned for slidable fit within a corresponding port 38 in pipe segment 12. Shell 40 may hold an associated ultrasonic transducer 15 or 17 near an inner end 41 thereof, and defines a passage 42 through which wiring 19 may pass for connecting the ultrasonic transducer to controller circuit board assembly 18 by way of an electrical connector 43. Shell 40 may be made from metal, for example stainless steel, or from plastic. The ultrasonic transducer 15 or 17 may be fitted into an insulating carrier 44 and mounted within shell 40. The transducer plug shell 40 and its corresponding port 38 may be cylindrical in shape as shown in the drawing figures, or they may be non-cylindrical in shape. The use of transducer plugs 14, 16 which slidably fit within a corresponding port 38 in pipe segment 12 facilitates efficient repair or replacement of the associated ultrasonic transducer 15, 17 in the event the ultrasonic transducer experiences a malfunction.

Ultrasonic transducers 15, 17 may be piezoelectronic transducer elements. By way of non-limiting example, ultrasonic transducers 15, 17 may be made of any of several materials suitable for generating the ultrasonic signal, such as Lead Zirconate Titanate (PZT) or Lead Metaniobate, quartz crystals, or other piezoelectric materials. Ceramic transducer elements made from PZT, supplied by Piezo Kinetics Inc. (PKI) or APC International may be used for practicing the present disclosure. A ceramic transducer element considered suitable in prototypes of cavitation sensor module 10 is a PZT circular disk, 10.2 mm Outer Diameter×1 mm thick, sold by APC International under Part No. 973.) Ultrasonic transducers 15, 17 may have a circular disk shape as shown in FIGS. 7 and 8, or a rectangular or square plate shape. Insulating carrier 44 provides electrical isolation between the ultrasonic transducer 15, 17 and the material of plug shell 40.

Transducer plugs 14 and 16 may be manufactured according to identical specifications, incorporating ultrasonic transducers 15 and 17 of the same model or part number, in order to benefit from economies of scale in production. The current embodiment has four ports in the pipe, so two pairs of ultrasonic transducers 15, 17 may be used to measure cavitation redundantly.

In a variant of the embodiment described above, a single ultrasonic transducer may be used in place of each ultrasonic transducer pair 15, 17. In that case, the single ultrasonic transducer would both transmit and receive the ultrasonic signal in a “pulse-echo” mode of operation. Multiple ultrasonic transducers operating in pulse-echo mode may be used to measure cavitation redundantly.

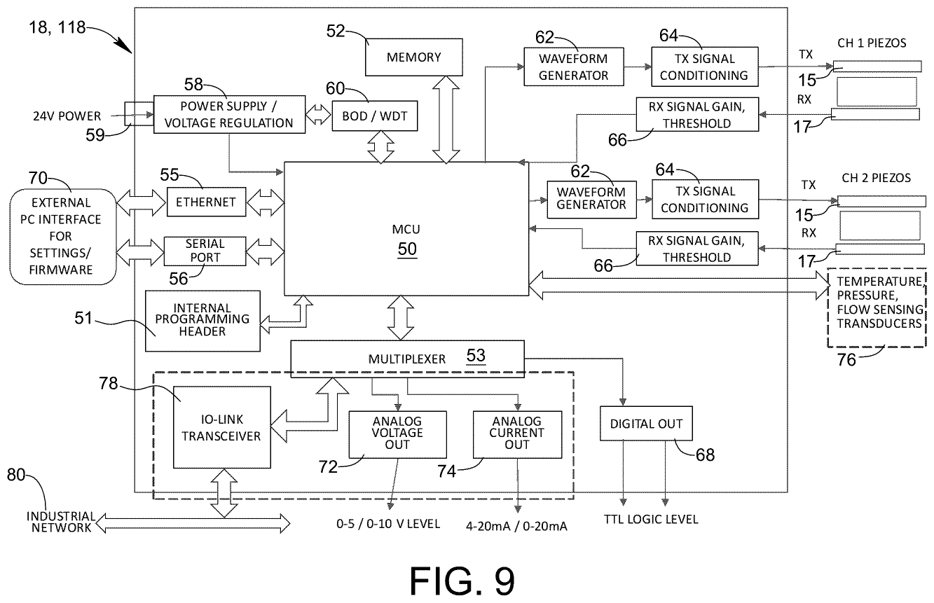

FIG. 9 schematically illustrates an embodiment of electronic controller board assembly 18. Controller board assembly 18 may include a programmable microcontroller 50, an internal programming header 51 connected to microcontroller 50, one or more digital memory devices 52 connected to microcontroller 50, a multiplexer 53 connected to microcontroller 50, and an Ethernet port 55 and serial port 56 enabling data communication between an external computing device 70 and microcontroller 50. Internal programming header 51 allows programming of microcontroller 50 in the factory, and is not user accessible.

Power may be supplied to components of controller board assembly 18 through a power supply/voltage regulator circuit 58 and a brown-out detection/watch dog timer circuit 60 connected to microcontroller 50.

Microcontroller 50 may be connected to send drive control signals to each first ultrasonic transducer 15 by way of a waveform generator circuit 62 and a transmission signal conditioning circuit 64. The strength and timing of the ultrasonic signals generated by each first ultrasonic transducer 15 may be controlled and adjusted by microcontroller 50 in accordance with programming instructions, for example firmware or software, executable by microcontroller 50. A user interface may be provided to enable users to enter control parameters and settings governing characteristics of the ultrasonic signals generated by each first ultrasonic transducer 15. External computing device 70, for example a personal computer, may function as such a user interface. Alternatively, or in addition, a touch-sensitive display panel (not shown) incorporated on enclosure 20 and connected for data communication with microcontroller 50 may function as a user interface.

The ultrasonic signals sent by each first ultrasonic transducer 15 through liquid in pipe segment 12 may be received by a corresponding second ultrasonic transducer 17. The cavitation detection signal generated by each second ultrasonic transducer 17 upon receiving an ultrasound signal may be processed by applying a signal gain (i.e., a scaling factor) and signal filtering at circuit 66. The amount of gain and filtering characteristics applied to the cavitation detection signal from each second ultrasonic transducer 17 may be controlled and adjusted by microcontroller 50 in accordance with programming instructions, for example firmware or software, executable by microcontroller 50. Users may enter control parameters and settings governing gain and filtering characteristics of the cavitation detection signals generated by each second ultrasonic transducer 17 by means of a user interface (e.g., external computing device 70) as described above.

Each circuit 66 provides a cavitation measurement signal to microcontroller 50. The cavitation measurement signal may be in the form of an analog voltage signal based on the cavitation detection signal from the associated second ultrasonic transducer 17, wherein signal noise is reduced by filtering and signal strength is increased by gain/scaling. The cavitation measurement signal may be digitized by an analog-to-digital converter which may be provided as part of microcontroller 50.

The cavitation measurement signal may be evaluated by microcontroller 50 to determine whether or not cavitation bubbles are present in the liquid between the first ultrasonic transducer 15 and the second ultrasonic transducer 17 paired therewith at a given measurement time. Microcontroller 50 may be configured to execute programming instructions, for example firmware or software stored in memory, causing the microcontroller to evaluate the amplitude of the cavitation measurement signal relative to one or more predetermined threshold values stored in memory 52. The threshold values may be determined based upon empirical testing. As a non-limiting example for sake of illustration, a liquid in conduit 30 having no cavitation bubbles present between first and second ultrasonic transducers 15, 17 may generate an output cavitation measurement signal of 3.0 V, and full air in conduit 30 between first and second ultrasonic transducers 15, 17 may generate an output cavitation measurement signal of 1.0 V. Thus, during operation, a cavitation measurement signal below 3.0 V will indicate the presence of at least one cavitation bubble, and there will be a correlation between the cavitation measurement signal and the extent of cavitation present in the liquid. The nearer the cavitation measurement signal is to 1.0 V, the greater the level of cavitation is in the liquid.

An alarm threshold value may be assigned corresponding to a level of cavitation bubbles approaching—but not yet reaching—a level of cavitation bubbles known to cause damage to a system surface or component. Microcontroller 50 may be programmed to turn on an alarm if the cavitation measurement signal crosses the alarm threshold. Continuing with the non-limiting example of the preceding paragraph, an alarm threshold such as 2.0 V may be assigned, and if the cavitation measurement signal drops below the alarm threshold, then microcontroller 50 will activate an alarm device (e.g., an audio and/or visual alarm) to indicate potentially harmful cavitation is present so that corrective action may be taken to prevent damage to components or surfaces of the liquid flow system. The corrective action may be manually implemented, or may be automated. For example, a pump flow rate may be reduced manually in response to the audio and/or visual alarm, or automatically in response to an alarm signal from microcontroller 50.

As mentioned above, a count of cavitation bubbles or an accumulation of cavitation present in the flowing liquid may be calculated by microcontroller 50 to provide additional information to a user. Microcontroller 50 may be programmed to detect a duration of time that the cavitation measurement signal “goes low” (i.e., dips under a predetermined threshold). If cavitation bubbles are relatively large, the detected duration may be used to estimate the total volume of cavitation bubbles. The detected duration information may also be used by microcontroller 50 to estimate the flow rate of the liquid flowing through pipe segment 12. Microcontroller 50 may also be programmed to count the number of cavitation bubbles sensed over time.

The ability to control and adjust characteristics of the ultrasound signals sent through the liquid and the resulting cavitation measurement signals provided to microcontroller 50, and the ability to assign or set relevant thresholds and ranges used by microcontroller 50 for evaluation of cavitation measurement signals, allows cavitation sensor module 10 to be configured based on specifications of the particular liquid flow system in which the cavitation sensor module is installed. Such specifications may include but are not limited to the type and physical properties of the flowing liquid, and the pumping flow rate or flow rate range.

As further indicated in FIG. 9, controller board assembly 18 may include a digital output 68, an analog voltage output 72, and an analog current output 74 connected to microcontroller 50. Additional sensors and transducers, represented at block 76, may be connected to microcontroller 50 to enhance the functionality of cavitation sensor module 10. Such additional sensors and transducers may include sensors and transducers for measuring or detecting pressure, temperature, flow rate, occlusions, and foreign debris in flow. For example, optical sensors may be connected to microcontroller 50 for detecting foreign debris in flow or other aspects of the flowing liquid. Controller board assembly 18 may also include an IO-Link transceiver 78 which will allow data and signal communication with an external industrial network 80.

Multiplexer 53 may be implemented between microcontroller 50 and the various outputs 68, 72, 74, and 78. As a result, two pins of a single 4-pin connector provide either (a) up to two digital outputs, or (b) up to two analog outputs, either voltage or current, or (c) an IO-Link output which is a “data” type of output (not just signal). The output type (a, b, or c) may be user-configurable.

In alternative implementations of the present disclosure, programmable microcontroller 50 may be replaced by a microprocessor, a computer, a field programmable gate array (FPGA), or even hardware-only electronics with no firmware or software involved.

As shown in FIGS. 2 through 4, enclosure 20 may be configured to enclose and protect transducer plugs 14, 16 and controller circuit board assembly 18 from environmental contaminants. For example, enclosure 20 may be sealed to prevent liquid from entering and damaging transducer plugs 14, 16 and controller circuit board assembly 18. Enclosure 20 may include a central piece 22A dimensioned to receive controller circuit board assembly 18 and a first radial portion of pipe segment 12, a cover piece 22B removably attached to central piece 22A and dimensioned to cover controller circuit board assembly 18, and a securement piece 22C removably attached to central piece 22A and dimensioned to receive a second radial portion of pipe segment 12 opposite the first radial portion of pipe segment 12 to secure enclosure 20 on the pipe segment. Cover piece 22B may be removably attached to central piece 22A by threaded fasteners (not shown) arranged in a plurality of aligned fastener holes 24 in cover piece 22B and central piece 22A. Securement piece 22C may be removably attached to central piece 22A by threaded fasteners (not shown) arranged in a plurality of aligned fastener holes 26 in securement piece 22C and central piece 22A. As may be seen in the figures, enclosure 20 may be configured such that the enclosure does not enclose couplings 32 of pipe segment 12, thereby enabling access to the couplings when cavitation sensor module 10 is installed in a piping system.

As may be understood, the multi-piece configuration of enclosure 20 according to the present disclosure enables pipe segment 12 with transducer plugs 14 and 16 to be installed in a piping system before the other components of cavitation sensor module 10 are installed. After pipe segment 12 with transducer plugs 14 and 16 is installed in the piping system, enclosure 20 containing controller circuit board assembly 18 may be mounted on pipe segment 12 and connection wiring 19 from ultrasonic transducers 15, 17 may be connected to controller circuit board assembly 18 by plugging electrical connectors 43 into corresponding connection sockets in the controller circuit board assembly. The multi-piece configuration of enclosure 20 also allows the cavitation sensor module 10, minus pipe segment 12 and transducer plugs 14 and 16, to be easily removed from a piping system.

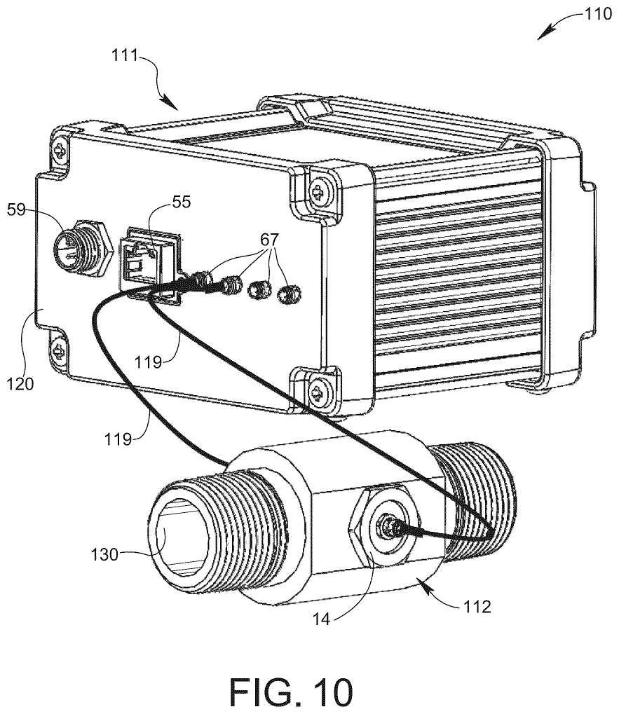

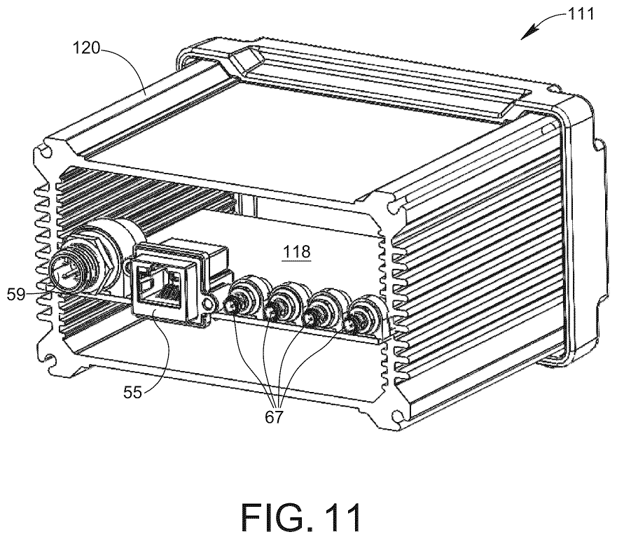

In the embodiments described above, the control electronics is mounted on the housing, for example on pipe segment 12 or on a pump housing. FIGS. 10-17 illustrate an ultrasonic cavitation sensor apparatus 110 according to another embodiment of the present disclosure, wherein the control electronics of the apparatus is located remote from the housing having the liquid flow conduit. Ultrasonic cavitation sensor apparatus 110 may generally comprise a control unit 111, a housing 112 (e.g., a pipe segment or a pump housing) and one or more first transducer plugs 14 each having a first ultrasonic transducer 15, one or more second transducer plugs 16 each having a second ultrasonic transducer 17 to be paired with a corresponding first ultrasonic transducer 15, and a controller circuit board assembly 118 located remote from the housing 112 within an enclosure 120 of control unit 111. Circuit board assembly 118 may be connected to each first ultrasonic transducer 15 and each second ultrasonic transducer 17 by transducer cables 119. As may be seen in FIG. 11, circuit board assembly 118 may include a coaxial power connector 59, Ethernet port 55, and a plurality of cable connectors 67 for connecting transducer cables 119 to circuit board assembly 118.

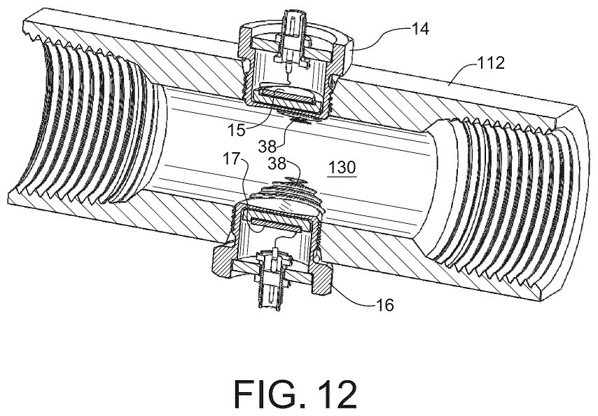

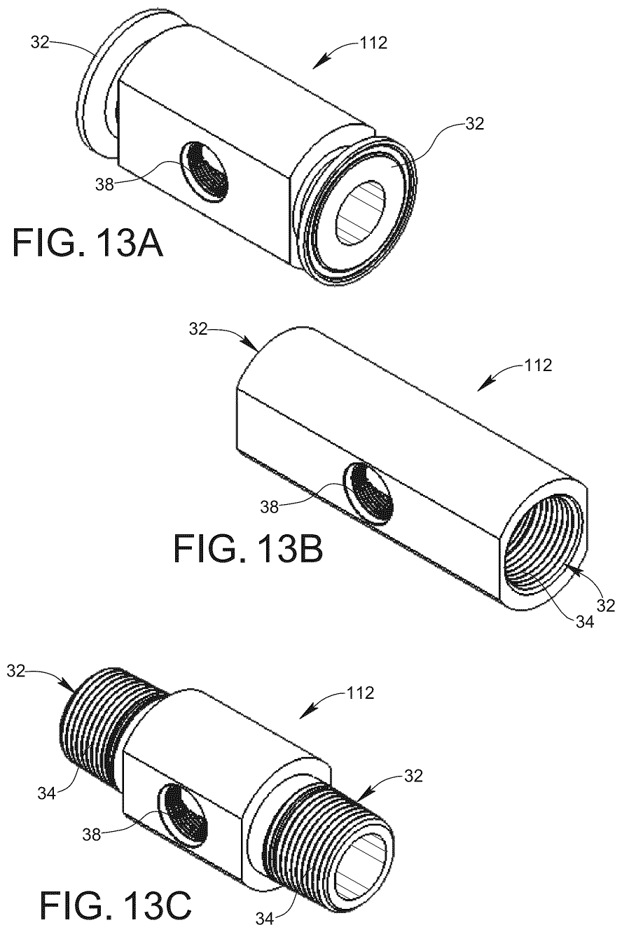

FIG. 12 shows housing 112 embodied as a pipe segment having a liquid flow conduit 30 and a pair of female pipe couplings 32 each having an internally threaded portion 34 for mating with system piping. Of course, other types of pipe segments may be used embody housing 112. For example, in FIG. 10, housing 112 is embodied by a pipe segment having a pair of couplings 32 having external threads 34. Examples of common pipe segment configurations useful as housing 112 are illustrated in FIGS. 13A through 13C. FIG. 13A shows a pipe segment having “sanitary flange” connection couplings 32. FIG. 13B shows a pipe segment having female NPT couplings 32, similar to housing 112 in FIG. 12. FIG. 13C shows a pipe segment having male NPT couplings 32, similar to housing 112 in FIG. 10. Sizing of the pipe segments may be adapted to meet system requirements, and standard sizes may be offered to fit nominal pipe sizes such as 1-inch, 1.5-inch, 2-inch, 2.5-inch, and 3-inch sizes. Of courses, larger or smaller sizes may be developed, and the configuration of couplings 32 is subject to design choice. Threaded ports 38 for receiving transducer plugs 14 and 16 may be drilled and tapped through a wall of housing 112 so that the transducer plugs are arranged coaxially across flow conduit 30 from each other. By using a standardized configuration for transducer plugs 14 and 16 and transducer ports 38, economies of scale and design simplicities are realized.

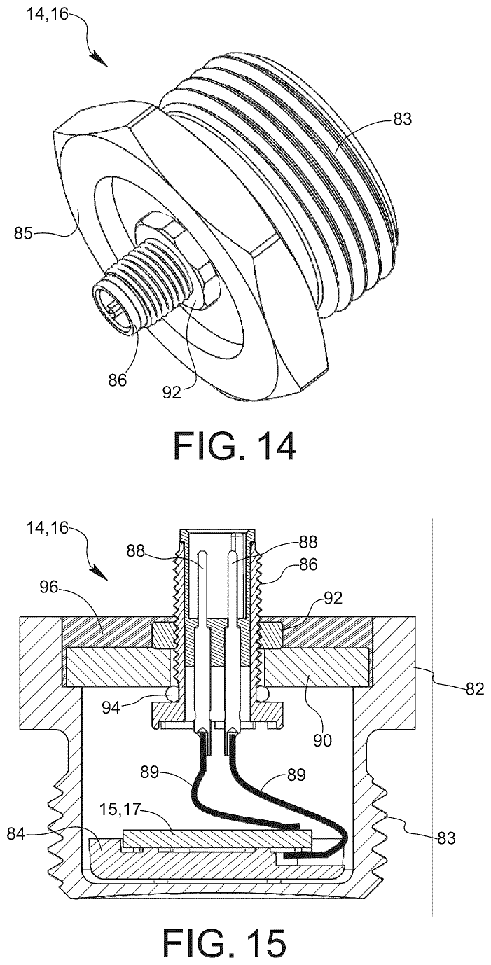

FIGS. 14 and 15 illustrate another embodiment of transducer plugs 14 and 16 according to the present disclosure. Plug 14, 16 is hermetically sealed and very modular. As may be seen, plug 14, 16 includes a plug housing 82 which may be machined from either plastic or metal, a carrier plate 84 which may be formed of plastic, a piezoelectronic transducer element 15, 17 supported by carrier plate 84, and a sealed connector 86 having a pair of contact members 88 connected to transducer element 15, 17 by a pair of wires 89. In the illustrated embodiment, connector 86 is fixed against a circular mounting plate 90 by a nut 92, and fluid-sealed with an O-ring 94. Mounting plate 90 may be fixedly held within plug housing 82 by adhesive potting 96. As may be understood, a transducer cable 119 may be removably connected at one end to connector 86 of transducer plug 14, 16 and at the opposite end to a cable connector 67 on circuit board assembly 118. Plug housing 82 includes an externally threaded portion 83 designed to mate with internally threaded ports 38 in housing 112 for easy installation and removal of the transducer plug 14, 16.

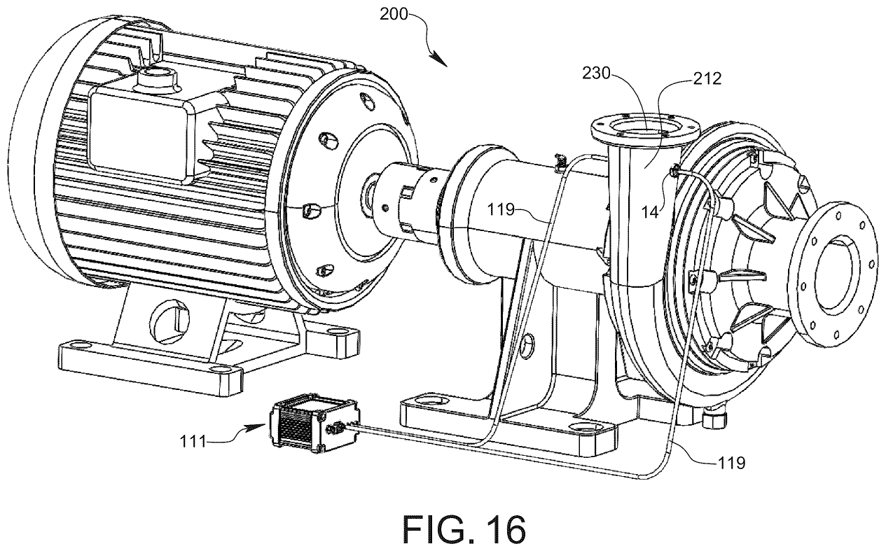

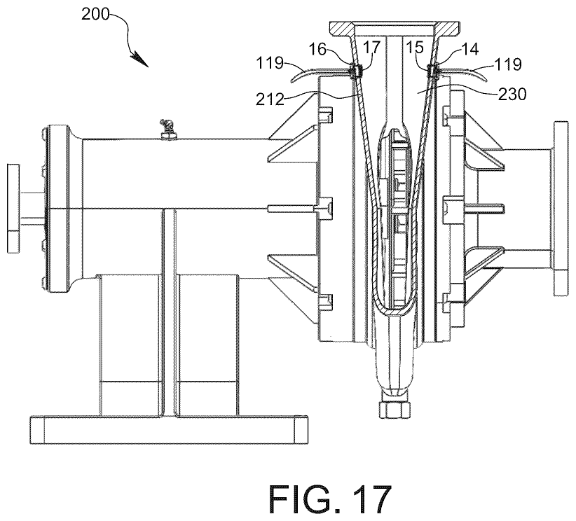

As shown in FIGS. 16 and 17, ultrasonic cavitation sensor apparatus 110 may be modified for installation on a pump housing 212 of a centrifugal pump 200, wherein the pump housing 212 takes the place of pipe segment 112. Pump housing 212 includes an outlet liquid conduit 230 and a plurality of ports 238 extending through a wall of the pump housing for receiving and positioning transducer plugs 14 and 16. Transducer plugs 14, 16 are threaded and have an O-ring seal for high pressure fluid sealing, so the outlet of pump housing 212 may be drilled and tapped with holes on a common center axis to form ports 238, and transducer plugs 14, 16 may be threaded into the ports 238.

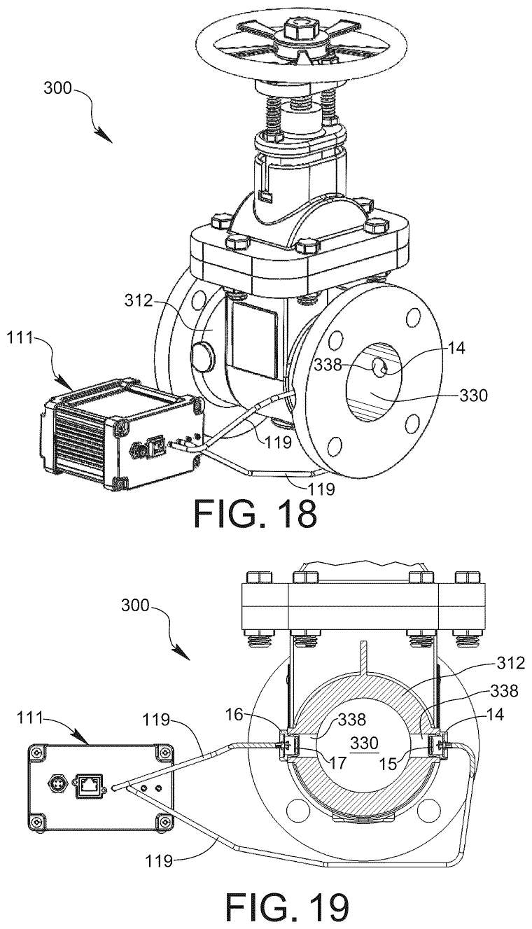

As shown in FIGS. 18 and 19, ultrasonic cavitation sensor apparatus 110 may be modified for installation on a valve housing 312 of a liquid flow valve 300, wherein the valve housing 312 takes the place of pipe segment 112. Valve housing 312 includes a liquid conduit 330 and a plurality of ports 338 extending through a wall of the valve housing for receiving and positioning transducer plugs 14 and 16. Transducer plugs 14, 16 are threaded and have an O-ring seal for high pressure fluid sealing. Valve housing 312 may be drilled and tapped with holes on a common center axis to form ports 338, and transducer plugs 14, 16 may be threaded into the ports 338.

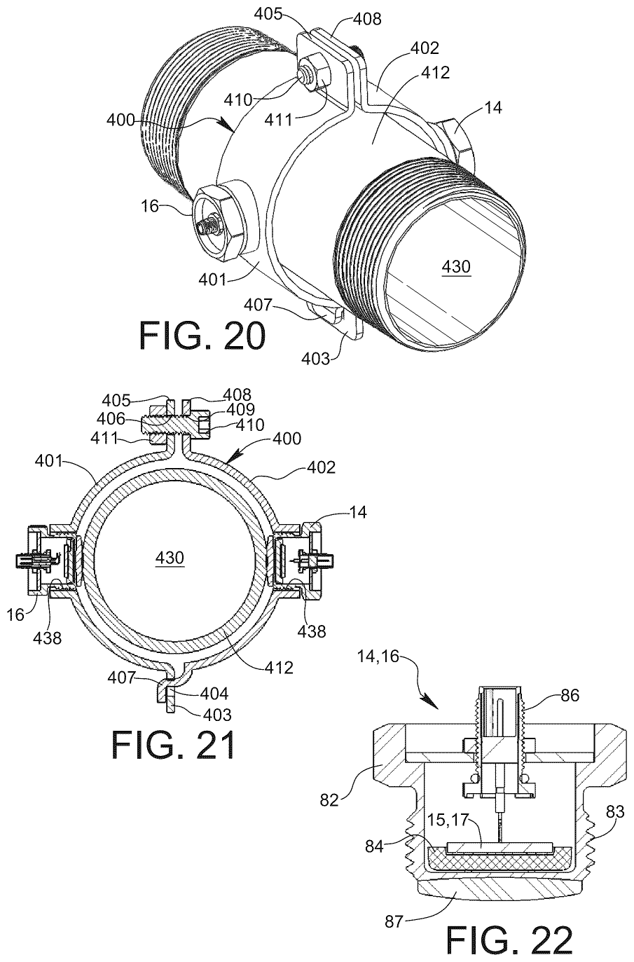

A “clamp-on” variant of the of the present disclosure is shown in FIGS. 20-22. In the clamp on variant, ultrasonic transducers 15, 17 may be installed on a clamp body 400 configured to be clamped onto an existing pipe segment or pipe 412, or another housing in an existing liquid flow system, having a liquid flow conduit 430. A clamp-on variant may be used in situations where a non-invasive installation is desired, i.e. in situations where it is not practical, safe, or possible to drill and tap an existing housing to access the liquid flow conduit and install transducer plugs 14, 16. The clamp-on variant is non-invasive because the transducer plugs 14, 16 do not protrude into the liquid conduit 430 through which liquid flows.

FIGS. 20 and 21 depict a simple example for clamping to cylindrical piping that comprises a clamp body 400 having a pair of arcuate brackets 401 and 402 designed to releasably mate with each other and tighten around cylindrical piping 412 within a range of outer diameters. In the embodiment shown, bracket 401 includes a first flange 403 having an opening 404 therethrough and a second flange 405 having a fastener hole 406 therethrough, and bracket 402 includes a first flange 407 bent to define a clasp sized for removable receipt through opening 404 and a second flange 408 having a fastener hole 409 therethrough. A bolt 410 may be arranged through aligned fastener holes 406, 409 and secured with a nut 411 to adjustably tighten clamp body 400 onto piping 412. Each bracket 401, 402 may include an internally threaded port 38 for respectively receiving and positioning a transducer plug 14, 16 such that when brackets 401, 402 are tightened together the corresponding transducers 15, 17 are axially aligned with one another across liquid conduit 430 of piping 412. While a simple clamp bracket is shown in FIGS. 20 and 21, other clamping configurations are of course possible, including but not limited to a linear sliding rail or a spring-loaded transducer housing. Transducer connection cables (not shown) may be provided to connect transducer plugs 14, 16 to control unit 111 as described above.

In the clamp-on variant, the ultrasound signal from each first ultrasonic transducer 15 must travel through the wall of housing 412 twice as the signal travels to reach the paired second ultrasonic transducer 17. Therefore, modifications that minimize the signal attenuation effects of the housing wall may be advantageous. Good coupling of the transducers 15, 17 to the exterior wall surface of housing 412 is important. For this reason, as best seen in FIG. 22, each transducer plug 14, 16 may include a compliant face pad 87 on an end face of plug housing 82. Compliant face pad 87 may be made of an elastomeric material to conform to the contour of the exterior wall surface of housing 412 when clamp body 400 is tightened onto housing 412. An ultrasonic coupling containing liquid or gel may be provided in association with each of the transducer plugs 14, 16 to aid propagation of ultrasonic energy between each ultrasonic transducer 15, 17 and the existing housing 412 to which the transducers are clamped. The strength of the transmitted ultrasound signals, and the gain applied to the received cavitation detection signals, may be increased to make up for ultrasonic signal attenuation caused by the housing wall.

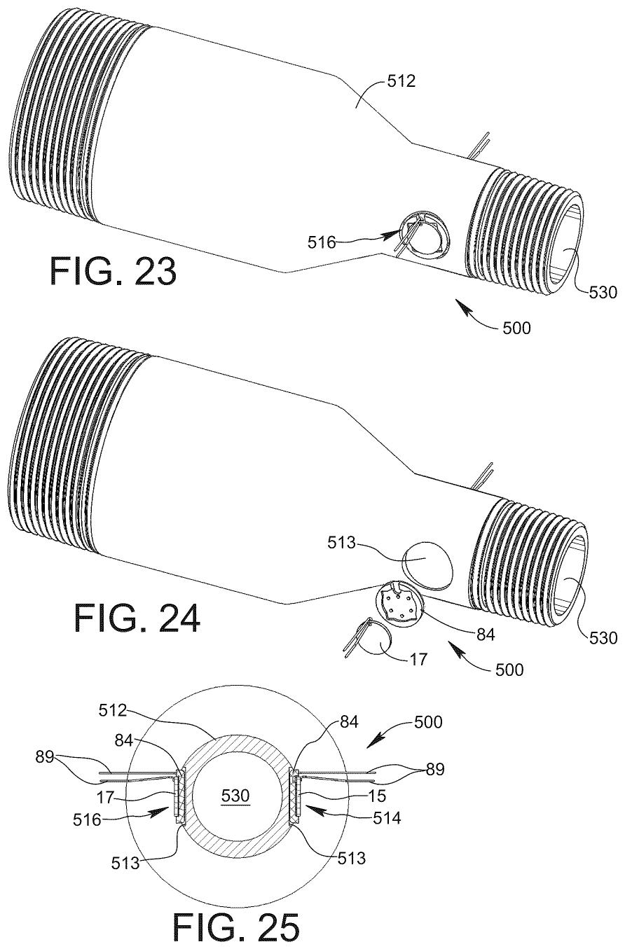

A bonded or adhered variant of the present disclosure is shown in FIGS. 23-25. In many cases, an application has physical space or weight constraints and the use of a transducer plug 14, 16 is not feasible. Or, in some cases, it may be undesirable to have a transducer plug configuration that is invasive and has a port 38 that may interrupt the otherwise smooth inner surface of a liquid conduit in a pipe, fitting, or other system component housing. In these cases, an ultrasonic transducer system 500 may be bonded to an exterior surface of the housing 512 of the component. For example, in the drawing figures, housing 512 is embodied as a reducer fitting where cavitation may be generated at an inner diameter transition of liquid conduit 530. The mounting area may be too small for an invasive transducer plug assembly, and if a transducer plug is installed, it may itself cause unwanted cavitation. In the bonded variant, transducer assemblies 514 and 516 may be mounted to the exterior of the fitting 512. Each transducer assembly 514, 516 may include a carrier plate 84 which may be formed of plastic, a piezoelectronic transducer element 15, 17 supported by and bonded to the carrier plate 84, and a pair of wires 89 connected to transducer element 15, 17. A suitable mounting location may prepared by machining a counterbore or flat surface 513 on the exterior surface of fitting 512. The carrier plate 84 of each transducer assembly 514, 516 may be bonded to surface 513 using suitable adhesive or bonding agent. As described above, axial alignment of paired transducer elements 15 and 17 is desirable. Wires 89 from each transducer element 15, 17 may be fed into a connection cable (not shown) that connects to a corresponding cable connector 67 on control unit 111.

As may be understood, each embodiment described herein as using paired transducers 15, 17 may be modified to operate using a single transducer operating in a pulse-echo arrangement.

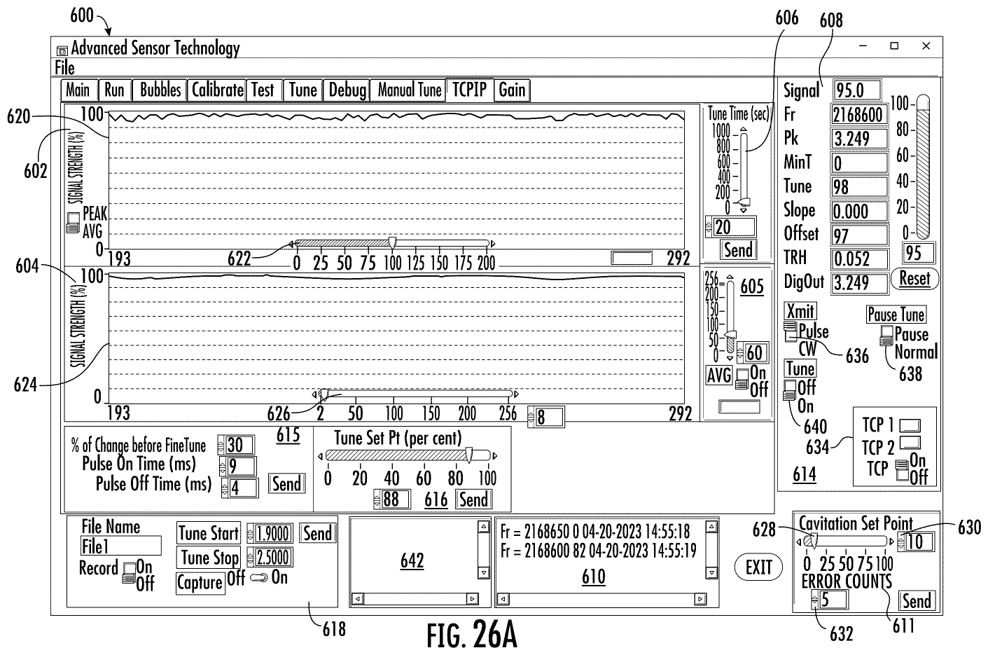

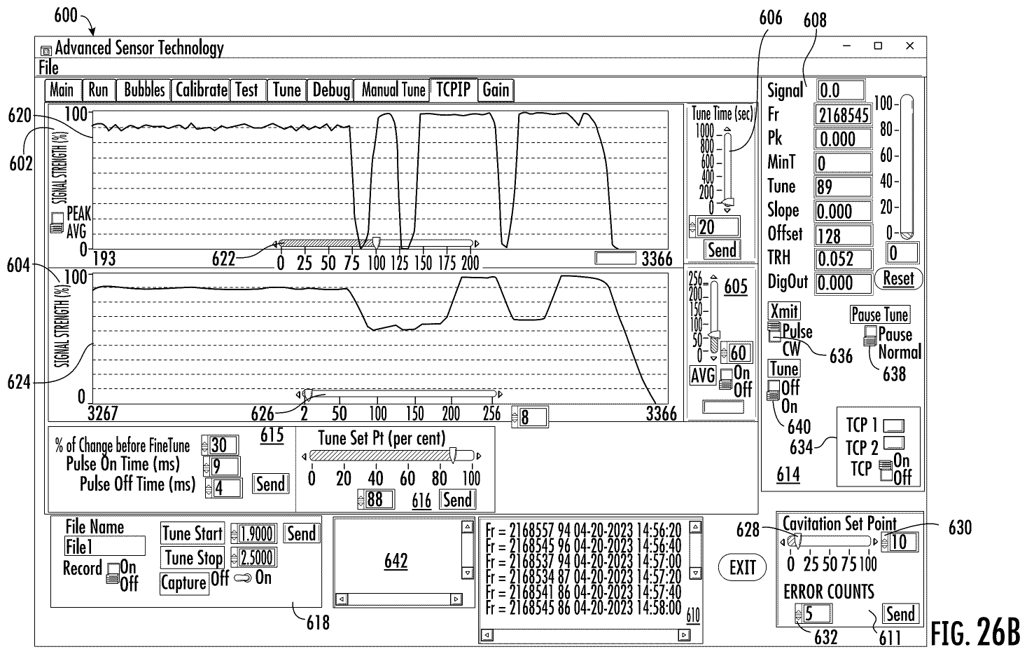

Reference is now made to FIGS. 26A and 26B for describing an optional user interface display screen 600 of the ultrasonic cavitation sensor apparatus 110. Screen 600 may be displayed on external computing device 70, for example a personal computer, and/or on a touch-sensitive display panel connected for data communication with microcontroller 50. A user interface is not required for use of cavitation sensor apparatus 110, as the sensor apparatus may operate in a standalone configuration to provide a digital and/or analog output signal to a connected device. However, a user interface may be provided and used for setting sensitivity parameters and general setup parameters of sensor apparatus 110.

User interface screen 600 enables a user to monitor functions of sensor apparatus 110 and to set operating parameters of sensor apparatus 110. FIG. 26A shows display screen 600 during operation of sensor apparatus 110 when no cavitation bubble is present, whereas FIG. 26B shows display screen 600 during operation of sensor apparatus 110 when four sets of cavitation bubbles are present. FIGS. 26A and 26B represent snapshots of screen 600 during operation of sensor apparatus 110, and certain portions of display screen 600 are dynamic and change as liquid flow conditions monitored by sensor apparatus 110 change.

Screen 600 may include a signal strip chart panel 602, an averaged signal strip chart panel 604, an averaging slider tool 605, a tuning slider tool 606, a signal data panel 608, a status text box 610, and a cavitation alarm setup panel 611. Screen 600 may include further interface items intended for use by factory set-up technicians and service technicians, as opposed to end users of sensor apparatus 110. These further items of screen 600 may include a communications configuration panel 614, tuning control panels 615 and 616, and a record capture panel 618. It is contemplated to provide a limited version of screen 600 lacking further items 614, 615, 616, and 618 for end user purposes, and an enhanced version of screen 600 including the further items 614, 615, 616, and 618 for factory and service technician purposes.

Signal strip chart panel 602 has a strip chart recorder 620 showing instantaneous strength of the received ultrasonic signal as a function of time, and may include a slider tool 622 for setting the number of points on the X-axis (time axis) of strip chart recorder 620. The signal strength range is indicated on the left side of the panel (0 to 100%). If the received signal is at 100%, it indicates that the liquid between the transmitting ultrasonic transducer 15 and the paired receiving ultrasonic transducer 17 has no cavitation bubbles. If the received signal is at 0%, it indicates that there is enough cavitation bubble formation present to block the transmitter-to-receiver path of the ultrasonic signal. A value between 0% and 100% indicates the relative size or volume of cavitation bubbles present in the transmitter-to-receiver path of the ultrasonic signal. Received signal strength is inversely proportional to the size of cavitation bubbles in the transmitter-to-receiver path of the ultrasonic signal.

Averaged signal strip chart panel 604 is similar to signal strip chart panel 602. Averaged signal strip chart panel 604 has a strip chart recorder 624 showing a smoothed average of the signal strength as a function of time rather than the instantaneous signal strength as shown in strip chart recorder 620. This difference is more readily apparent in FIG. 26B than FIG. 26A. Averaged signal strip chart panel 604 may include a slider tool 626 for setting the number of points on the X-axis (time axis) of strip chart recorder 624. Averaging slider tool 605 sets the time interval over which signal strength is averaged in strip chart recorder 624.

Tuning slider tool 606 sets a time between tuning events during which a resonant frequency of first ultrasonic transducer 15 is found in order to transmit at maximum signal strength. For example, the tuning event may involve a frequency sweep of first ultrasonic transducer 15 to find the resonant frequency.

Signal data panel 608 displays instantaneous measurement data of the ultrasonic transducers 15, 17 such as received signal strength, transmitter frequency, peak voltage of receiving transducer 17, and other measurement data. The received signal strength indicated in signal data panel 608 is the same as the instantaneous signal strength represented in the strip chart recorder 620 at the right edge (right vertical axis) of strip chart recorder 620.

Status text box 610 displays data that is being recorded by sensor apparatus 110.

Cavitation alarm setup panel 611 includes interface tools enabling a user to establish one or more alarm conditions for triggering generation of a cavitation alarm signal based on characteristics of the cavitation measurement signal. The alarm conditions may include a cavitation occurrence condition that is met when a strength of the cavitation measurement signal falls below a cavitation alarm set point. For example, if through observation by the user it is determined that system damage potentially occurs when strength of the cavitation measurement signal drops below 10%, then the cavitation alarm set point may be set at 10% as shown in FIGS. 26A and 26B. Cavitation alarm setup panel 611 may include a set point slider tool 628, a set point scroll 630, and/or other user interface input tools by means of which a user may enter a variable user input for establishing the cavitation alarm set point.

Microcontroller 50 may be programmed to register a cavitation error count corresponding to a consecutive number of times the cavitation occurrence condition has been met, and the alarm conditions may further include a cavitation error count condition that is met when the cavitation error count equals a cavitation error count setting specified by a user. As may be understood, the error count setting may be set to a value high enough to eliminate nuisance alarms. For example, in FIGS. 26A and 26B, the cavitation error count setting is set to five, so that five consecutive events in which the cavitation occurrence condition is met (i.e., the cavitation measurement signal drops below the cavitation alarm set point) are required to cause the output alarm. In one embodiment, the error count setting may be set to any integer value from 1 to 1000, however other ranges may be provided for the error count setting. Cavitation alarm setup panel 611 may include an error count scroll 632 and/or other user interface input tools by means of which a user may enter a variable user input for establishing the error count setting.

Communications configuration panel 614 includes switches used to facilitate communications between an external computing device 70 and the ultrasonic transducers 15, 17 for debugging and development purposes. Switch 634 controls Transmission Control Protocol (TCP) so that external computing device 70 may be selectively enabled as host by Ethernet connection. Switch 636 changes the operational mode of the ultrasonic transducers between a pulse transmission mode and a continuous transmission mode. Switch 638 pauses tuning sweeps for debugging purposes. Switch 640 turns tuning ON and OFF (when tuning is OFF, the ultrasonic transducers operate at a static frequency).

Tuning control panels 615 and 616 enable technicians to input other settings for development and debugging purposes. Tuning control panel 615 allows a user to alter ultrasonic transducer pulse and tuning settings. Tuning control panel 616 allows a user to adjust a tuning set point (i.e., an acceptable level for maximum reading). This panel will not be available in the commercial version.

Record capture panel 618 allows a user to set a file name for recording data, set a tuning range, and enable and disable capture for a status box 642.

As mentioned above, communications configuration panel 514, tuning control panels 615 and 616, and record capture panel 618 are intended for use by factory and service technicians, and may be omitted from a commercial version of user interface screen 600 available to end users.

FIG. 26A shows user interface screen 600 when no cavitation bubbles are present. As may be seen in strip chart recorders 620 and 624, the strength of the cavitation measurement signal remains very high. By contrast, FIG. 26B shows user interface screen 600 when several cavitation bubbles are present. Strip chart recorders 620 and 624 show at least four large cavitation events where the instantaneous strength of the cavitation measurement signal drops to nearly 0%. The trace of strip chart recorders 620 and 624 is moving from right to left, such that the current cavitation measurement signal strength is on the right axis (right edge) of each chart.

The numeric strength value of the current instantaneous signal is displayed in the top text box in signal data panel 608. In this example, the signal strength is 0.0%. If the signal strength drops below the cavitation alarm set point and meets the cavitation error count setting inputted by a user at cavitation alarm setup panel 611, program instructions executed by microcontroller 50 cause the microcontroller to generate a cavitation alarm signal. The cavitation alarm signal may be transmitted to external control equipment connected directly or over industrial network 80 to circuit board assembly 118. For example, the cavitation alarm signal may be transmitted to a flow valve controller and/or a pump controller to automatically reduce or halt liquid flow through conduit 130 in response to the alarm signal to prevent cavitation damage before it begins. Alternatively or additionally, the cavitation alarm signal may be transmitted to trigger audible and/or visible alarm equipment to alert personnel of cavitation. If a cavitation alarm signal is generated, a visual indication of the alarm signal may be provided on user interface screen 600, such as changing a color of the top text box in signal data panel 608 to red to show alarm status.

Cavitation sensor module 10 and cavitation sensor apparatus 110 of the present disclosure directly detect and measure cavitation vapor bubbles in flowing liquid. This differs from the aforementioned indirect sensing methods which detect an artifact of cavitation such as noise, vibration, or pump behavior. Consequently, cavitation bubbles are detected before they can be heard acoustically or seen visually so that equipment damage may be prevented. Moreover, the cavitation can be quantified by measuring the size and/or number of bubbles present. Cavitation may be detected at a very low level, and the sensing logic is adjustable or tunable to ignore cavitation below a set level where the cavitation is only a nuisance and not damaging. Unlike some indirect cavitation sensors of the prior art, cavitation sensor module 10 and cavitation sensor apparatus 110 of the present disclosure are suitable for use in noisy environments. Cavitation sensor module 10 and cavitation sensor apparatus 110 are compact and inexpensive to produce.

Cavitation sensors of the present disclosure, and the methodology employed thereby, find useful application in heavy industry to protect expensive pump systems from potential cavitation damage. Other applications include predictive maintenance, leak detection, and safety alarms.

While the disclosure describes various exemplary embodiments, the detailed description is not intended to limit the scope of the disclosure to the particular forms set forth. The disclosure is intended to cover such alternatives, modifications and equivalents of the described embodiment as may be apparent to one of ordinary skill in the art.

What is claimed is:

1. An apparatus for sensing cavitation in liquid flowing through a liquid conduit, the apparatus comprising:
an ultrasonic transducer system including one or more ultrasonic transducers each arranged in acoustic communication with the liquid flowing through the conduit; and
control electronics connected to the ultrasonic transducer system, the control electronics being configured to drive the ultrasonic transducer system to send an ultrasonic signal through liquid flowing through the conduit, wherein the ultrasonic transducer system receives the ultrasonic signal and generates an electronic cavitation detection signal representing a strength of the ultrasonic signal as received by the ultrasonic transducer system;
the control electronics being further configured to process the cavitation detection signal to i) provide a cavitation measurement signal indicative of whether or not the ultrasonic signal interacted with one or more cavitation bubbles in liquid flowing through the conduit, ii) evaluate the cavitation measurement signal to determine if one or more cavitation alarm conditions is met, and iii) output an alarm signal when each of the one or more cavitation alarm conditions is met.

2. The apparatus according to claim 1, further comprising a housing having the conduit, wherein each of the one or more ultrasonic transducers is attached to the housing.

3. The apparatus according to claim 1, wherein the one or more ultrasonic transducers of the ultrasonic transducer system includes a first ultrasonic transducer and a second ultrasonic transducer facing the first ultrasonic transducer across the conduit, wherein the control electronics is configured to drive the first ultrasonic transducer to send the ultrasonic signal through liquid flowing through the conduit, and wherein the second ultrasonic transducer receives the ultrasonic signal and generates the electronic cavitation detection signal.

4. The apparatus according to claim 1, wherein the one or more ultrasonic transducers of the ultrasonic transducer system includes a single ultrasonic transducer, wherein the control electronics is configured to drive the single ultrasonic transducer to send the ultrasonic signal through liquid flowing through the conduit such that the ultrasonic signal is retro-reflected by the housing back to the single ultrasonic transducer, and wherein the single ultrasonic transducer receives the ultrasonic signal and generates the electronic cavitation detection signal.

5. The apparatus according to claim 1, further comprising a user interface connected to the control electronics.

6. The apparatus according to claim 5, wherein the user interface is configured to display the cavitation measurement signal and/or a value representing an instantaneous strength of the cavitation measurement signal.

7. The apparatus according to claim 5, wherein the control electronics has a cavitation alarm set point, and the one or more cavitation alarm conditions includes a cavitation occurrence condition that is met when a strength of the cavitation measurement signal falls below the cavitation alarm set point.

8. The apparatus according to claim 7, wherein the user interface is configured to receive a first variable user input for establishing the cavitation alarm set point.

9. The apparatus according to claim 7, wherein the control electronics has a cavitation error count setting, the control electronics is configured to register a cavitation error count corresponding to a consecutive number of times the cavitation occurrence condition has been met, and the one or more cavitation alarm conditions includes a cavitation error count condition that is met when the cavitation error count equals the cavitation error count setting.

10. The apparatus according to claim 9, wherein the user interface is configured to receive a second variable user input for establishing the cavitation error count setting.

11. The apparatus according to claim 1, wherein the control electronics is located remote from the housing.

12. The apparatus according to claim 1, wherein the control electronics is mounted on the housing.

13. The apparatus according to claim 1, wherein the housing is selected from a group of housings consisting of a pipe segment, a pump housing, a valve housing, and a flow reducer.

14. A method for sensing cavitation in liquid flowing through a conduit, the method comprising the steps of:
arranging a first ultrasonic transducer in acoustic communication with the liquid flowing through the conduit;
arranging a second ultrasonic transducer in acoustic communication with the liquid flowing through the conduit, wherein the second ultrasonic transducer faces the first ultrasonic transducer across the conduit;
driving the first ultrasonic transducer to send an ultrasonic signal through liquid flowing through the conduit;
receiving, by the second ultrasonic transducer, the ultrasonic signal;
generating, by the second ultrasonic transducer, an electronic cavitation detection signal representing a strength of the ultrasonic signal as received by the second ultrasonic transducer;
processing the cavitation detection signal to provide a cavitation measurement signal indicative of whether or not the ultrasonic signal interacted with one or more cavitation bubbles in liquid flowing through the conduit;
evaluating the cavitation measurement signal to determine if one or more cavitation alarm conditions is met; and
outputting an alarm signal when each of the one or more cavitation alarm conditions is met.

15. The method according to claim 14, further comprising the step of displaying the cavitation measurement signal and/or a value representing an instantaneous strength of the cavitation measurement signal.

16. The method according to claim 15, wherein the one or more cavitation alarm conditions includes a cavitation occurrence condition, and wherein the step of evaluating the cavitation measurement signal includes comparing a strength of the cavitation measurement signal to a predetermined cavitation alarm set point, and determining that the cavitation occurrence condition is met when a strength of the cavitation measurement signal falls below the cavitation alarm set point.

17. The apparatus according to claim 16, wherein the one or more cavitation alarm conditions includes a cavitation error count condition, and wherein the step of evaluating the cavitation measurement signal includes registering a cavitation error count corresponding to a consecutive number of times the cavitation occurrence condition has been met, and determining that the cavitation error count condition is met when the cavitation error count equals a predetermined cavitation error count setting.
